(19) United States
(12) Patent Application Publication
(10) Pub. No.: US 2023/0006298 A1
(43) Pub. Date: Jan. 5, 2023

(54) Supporting structure for receiving battery cells

(71) Applicant: Webasto SE, Stockdorf (DE)

(72) Inventors: Michael Schönberger, Stockdorf (DE); Jochen Haussmann, Stockdorf (DE)

(21) Appl. No.: 17/781,679

(22) PCT Filed: Dec. 3, 2019
(86) PCT No.: PCT/EP2019/083459

§ 371 Date: Jun. 1, 2022

(51) Int. Cl. H01M 50/244; B60L 50/64; H01M 50/249; H01M 10/6556; H01M 50/35

(52) U.S. Cl. CPC H01M 50/244; B60L 50/64; H01M 50/249; H01M 10/6556; H01M 50/35; H01M 2220/20

(57) ABSTRACT

The present invention pertains to a supporting structure for receiving battery cells in a battery system of a hybrid or electrical vehicle, the supporting structure comprising a bottom plate and two side plates arranged on the bottom plate, wherein the inner sides of the two side plates and the bottom plate define an internal volume for receiving the battery cells and wherein each side plate comprises a flange at its outer side and wherein each flange comprises fixation means for fastening the supporting structure to an adjacent supporting structure.

### CROSS-REFERENCE TO RELATED APPLICATIONS

This application is a 35 U.S.C. § 371 National Stage Entry of International Application No. PCT/EP2019/083459 filed Dec. 3, 2019, which is incorporated herein by reference in its entirety for all purposes.

### TECHNICAL FIELD

The invention relates to a supporting structure for receiving battery cells and more particularly to a supporting structure which can be used to assemble a modular battery system as a traction battery for a hybrid or electrical vehicle.

### BACKGROUND

Electric vehicles driven by an electric motor or hybrid vehicles, driven by both an electric motor and an internal combustion engine, carry on board a battery with a plurality of battery modules, which are electrically and mechanically connected to form a battery system as a traction battery. It is known to compose each battery module of a plurality of battery cells, placed inside a module housing. To form the traction battery, the battery modules are typically contained in a battery housing.

There exists an increasing demand for always larger battery systems, in order to enable longer range of vehicles and on the other side to enable electrical propulsion of bigger vehicles like trucks, buses or construction vehicles. Usually battery modules are placed on a carrier plate of the battery housing, which has to be strong enough to carry the weight of the modules. The increasing amount of battery modules requires also increased stability of the battery system, especially of the carrier plate and this in turn results in increased weight of the whole system, which is unfavorable.

Besides the growing number of battery modules, it is desirable that battery system construction remains adaptable, such that the shape of the battery system is adapted to the space available for its accommodation. This is especially advantageous for vehicles where the predefined space for the battery system is often very limited and/or of an irregular shape.

Furthermore, temperature control of battery cells has to be tackled accordingly to ensure a good battery performance. It is advantageous to have fluid channels for temperature control already incorporated in a housing of a battery module to avoid additional building parts and installation requirements as well as additional weight. It is also advantageous for battery cells to be in direct contact with a cooling and/or heating plate in order to maximize heat transfer.

All these different perspectives have already been addressed in the past individually. DE102011077330A1 describes placement and fixation of battery cells directly on a base plate, wherein the base plate can also be a cooling plate at the same time. DE102012205810A1 discloses a housing for a battery module, which has fluid channels for temperature control implemented in its base plate. DE 102016213832A1 relates to a bottom shell of a battery pack housing, which is formed by extrusion and has build in fluid channels for temperature control of battery cells. US 2014287292A1 describes a temperature regulating element, which serves as a base plate for direct accommodation of battery cells thereon.

EP3331055A1 describes a battery module carrier composed of a bottom plate and two side walls and a carrier frame accommodating a plurality of battery module carriers, wherein each battery module carrier can individually be attached or detached from the carrier frame. The battery module carrier also contains cooling channels for dissipating heat generated by battery cells.

### SUMMARY OF THE INVENTION

It is an object of the present invention to provide an improved modular supporting structure for receiving battery cells in a battery system, preferably in a hybrid or electric vehicle.

The object is solved by a supporting structure defined as in claim 1. Preferred embodiments are defined in the dependent claims, the general description of the invention as well as the description of specific embodiments and the drawings.

The supporting structure for receiving battery cells in a battery system, preferably in a hybrid or electrical vehicle, comprises a bottom plate and two side plates arranged on the bottom plate, wherein the inner sides of the two side plates and the bottom plate define an internal volume for receiving the battery cells. Each side plate comprises a flange at its outer side and each flange comprises fixation means for fastening the supporting structure to an adjacent supporting structure.

By the provision of the flanges and fixation means it is possible to assemble a modular battery system by connecting at least two adjacent supporting structures to one another and achieve a structurally sound arrangement. Depending on the actual needs of different specific vehicles, it is possible to adapt the dimensions of the resulting battery system while using the same components and in particular by using the same supporting structure for a greater number of different vehicles and battery systems.

By using the flanges of the side plates of the supporting structure, the supporting structure can furthermore be attached directly to the chassis or to any other receiving frame or to another supporting structure.

Preferably, the supporting structure is self-supporting, meaning that no additional carrier plate or housing is needed to achieve a mechanically stable battery system. By this measure it is possible to build a mechanically intact modular battery system on the basis of the supporting structures only.

Preferably, the bottom plate and/or the side plates are provided by an extruded material, preferably by an extruded profile and/or wherein the bottom plate and the side plates are integrally formed. Using extruded material and in particular extruded profiles the supporting structure can be provided in a cost effective manner and infinite in dimensions along the extrusion direction.

In a further preferred embodiment, the side plates may be fastened to the bottom plate by a form-locking connection or by a screw connection or may be glued or welded to the bottom plate.

Preferably, at least one flange extends from its respective side plate at an angle, preferably perpendicularly. By arranging the flange at an angle and in particular at a right angle, the supporting structure can be easily assembled to an adjacent supporting structure or any other neighboring structure.

Preferably, the flange of one side plate is arranged at a different distance from the bottom plate as the flange of the other side plate, wherein the distance of the flanges from the bottom plate preferably differs by the thickness of the material of the flanges. By arranging the flanges of a supporting structure at different heights it becomes possible to connect two neighboring supporting structures such that their respective adjacent flanges overlap without colliding.

Preferably, the flanges on both side plates are positioned at different heights, such that two flanges of adjacent supporting structures come into close contact upon interconnection of the corresponding bottom plates.

Preferably, each flange is positioned approximately midway along the side plate. This leads to a structurally stable arrangement.

Preferably, each flange extends in a direction parallel to the plane defined by the bottom plate from its respective side plate further than the bottom plate, preferably for forming an overlap between two adjacent flanges of two adjacent supporting structures.

Preferably, the bottom plate comprises a fluid channel for receiving a temperature control fluid for controlling the temperature of the internal volume, preferably for controlling the temperature of battery cells received within the internal volume. This way the cooling/heating system is incorporated into the supporting structure and no external system for temperature control is needed, which reduces weight, assembly time and production cost.

To maximize heat transfer between the fluid channels and the battery cells, in a preferred embodiment, the supporting structure forms part of a module housing, such that the battery cells are placed directly on the bottom plate and between the side plates. This again simplifies battery assembly and reduces maintenance costs.

Preferably, the battery cells are positioned directly in the internal volume, preferably directly on the bottom plate and between the side plates of the supporting structure for forming a battery module.

Preferably, the bottom plate comprises a venting channel for receiving gases released from the battery cells in case of thermal runaway. The venting channel is connected to a common venting path, wherein the venting path connects venting outlets of all battery cells accommodated on the supporting structure and conveys released gases to the venting channel and through it to the outside of the battery system.

Preferably, the bottom plate comprises at least one edge having connection means, preferably a connection geometry enabling a form-locking and/or clip connection with an adjacent supporting structure. By connecting one support structure to an adjacent support structure not only at the flanges but also at the bottom plate, a very stable modular battery system can be achieved. In particular, as the planes in which the connection between the two bottom plates on the one hand and the two flanges on the other hand take place are spaced apart from one another, the structural and mechanical stability of the connection can be enhanced.

The above mentioned object is also solved by a battery system with the features of claim 14. Preferred embodiments are defined in the dependent claims, the general description of the invention as well as the description of specific embodiments and the drawings.

Accordingly, the battery system comprises at least two supporting structures for receiving battery cells wherein the supporting structures are provided in the form as already discussed above and wherein the supporting structures are interconnected at the respective adjacent bottom plates as well as at the respective adjacent flanges.

Preferably, each bottom plate comprises connection means for enabling a form-locking and/or clip connection of two adjacent bottom plates. Preferably, the appropriate geometry for the form-locking and/or clip connection is already incorporated into the bottom plate.

Mechanical connection of the bottom plates ensures stability of the connected supporting structures in the plane defined by the bottom plate. By mechanically connecting the side plates of the two adjacent supporting structures via their respective flanges, the stability of the battery system is further enhanced, since this way also the movement perpendicular to the bottom plates is suppressed. Furthermore, a connection in two planes which are distanced from each other is achieved.

### BRIEF DESCRIPTION OF THE DRAWINGS

The present disclosure will be more readily appreciated by reference to the following detailed description when being considered in connection with the accompanying drawings in which:

FIG. 1 illustrates a schematic perspective view of a supporting structure for receiving battery cells;

FIG. 2 illustrates a schematic perspective view of a section of a battery system comprising two adjacent supporting structures in the process of being coupled;

FIG. 3 illustrates a schematic perspective view of the section of the battery system shown in FIG. 2 comprising two adjacent supporting structures being coupled; and

FIG. 4 illustrates a schematic perspective view of a supporting structure with inserted battery cells.

### DETAILED DESCRIPTION OF PREFERRED EMBODIMENTS

In the following, the invention will be explained in more detail with reference to the accompanying figures. In the Figures, like elements are denoted by identical reference numerals and repeated description thereof may be omitted in order to avoid redundancies.

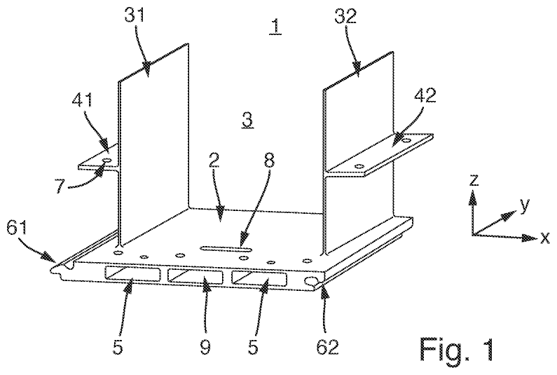

FIG. 1 illustrates a schematic view of a supporting structure 1, comprising a bottom plate 2, a left side plate 31 and a right side plate 32, a flange 41 extending on the outer side of the left side plate 31 and a flange 42 extending on the outer side of the right side plate 32 and fluid channels 5. An internal volume 3 is defined between the bottom plate 2 and the side plates 31, 32.

The terms “left” and “right” are to be understood related to the Figures only and are intended to serve to more easily identify the different side plates. The terms are, however, not to be interpreted in an absolute sense such that in a different perspective or orientation of the supporting structure 1, the “left” side plate could also be on the right or at the back or at the front or at the top or at the bottom.

Likewise the term “side” and “bottom” are to be understood with respect to the Figures which show a preferred example of orientation. However, the components could also be situated in a different location in a different perspective or orientation of the support structure.

A plurality of battery cells may be received in the internal volume 3 between the bottom plate 2 and the inner sides of the side plates 31, 32. The supporting structure 1 together with battery cells (and any wiring/contact bars and/or control electronics may constitute a battery module.

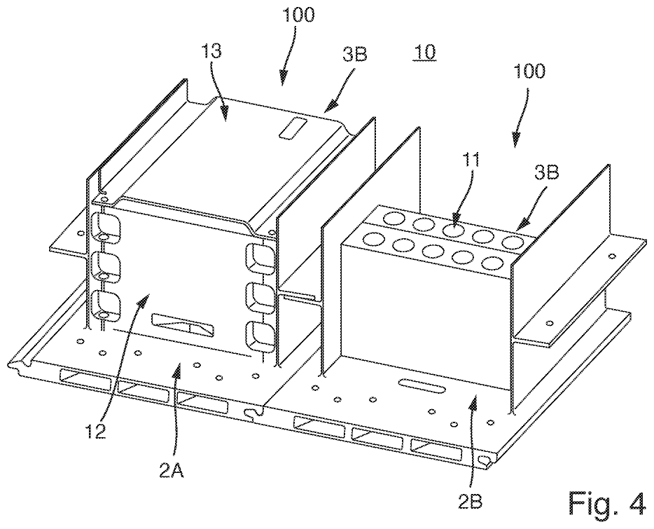

A plurality of battery modules 100 may be combined to a battery system 10 for a hybrid or electrical vehicle. This will be shown in more detail in FIG. 4. The battery system 10 preferably serves as a traction battery for providing an electric drive of the hybrid or electric vehicle with electric power.

Turning back to FIG. 1, the bottom plate 2 of the support structure 1 is preferably self-supporting such that no additional carrier plate or housing is needed to hold the weight of the supporting structure 1 including the components received in the internal volume 3 during use. Such self-supporting bottom plate 2 may be produced by an extrusion process.

The bottom plate 2 may hence be made of an extruded aluminum profile, an aluminum casting part, reinforced plastic extrusion profile or casting part or of an aluminum or steel deep drawn part.

Further, the bottom plate 2 preferably comprises at least one fluid channel 5 for receiving a temperature control fluid for controlling the temperature of the internal volume 3 and, thus, of the battery cells received therein.

Providing temperature control of a battery module or a battery in a battery housing by means of a temperature control fluid is, in principle, known. If cooling of the battery components is required, the temperature control fluid is typically processed to have a lower temperature than the temperature in the internal volume 3. If a heating of the battery components is required, the temperature control fluid is typically processed to have a higher temperature than the temperature in the internal volume 3. The temperature control fluid is made to flow through the fluid channels 5 in order to enable temperature control of the inner volume 3 by means of temperature exchange.

There are two fluid channels 5 shown in FIG. 1, which are part of the extruded profile forming the bottom plate 2. The fluid channels 5 run in parallel to each other in the exemplary implementation of this invention. However, the number and realization of fluid channels may vary in different implementations of this invention. The fluid channels 5 are a feature of the extruded profile.

The bottom plate 2 may also comprise a venting channel 9 for receiving gases released from the battery cells in case of a thermal runaway. A venting opening 8 connects a common venting arrangement to the venting channel 9. The common venting arrangement is arranged such that the venting outlets of a number or all battery cells received in the inner volume 3 of the supporting structure 1 are combined and connected such that gases released by one or more than one battery cells are conveyed to the venting channel 9 and through it to the outside of the battery system. In other words, the common venting arrangement acts as a manifold for the venting outlets of the individual battery cells.

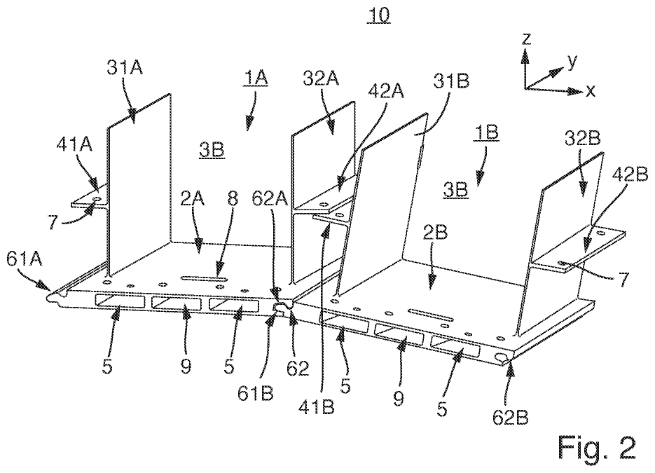

Two opposing edges 61, 62 of the bottom plate 2 that run parallel to fluid channels 5 and also parallel to the side plates 31, 32, have a complementary geometry in order to enable a direct connection between at least two such adjacent bottom plates 2, which will further be explained with reference to FIG. 2.

In the Figures and preferred embodiments, the direct connection between adjacent bottom plates 2 is formed as a clip connection such that each two bottom plates 2 can be securely connected to each other without needing any additional fastening means. Accordingly, the left edge 61 of the bottom plate 2 is formed as a male part of a clip connection and the right edge 62 is formed as a female part of the clip connection.

The side plates 31, 32 are arranged on the bottom plate 2 to form the supporting structure 1 and to define the internal volume 3.

Bottom plate 2 and the side plates 31, 32 may be formed integrally—for example by extrusion.

In a different embodiment, side plates 31, 32 may be fixed to the bottom plate 2 by a screw connection or by a form-locking connection or by any other appropriate connection that offers sufficient stability. Side plates 31, 32 may also be glued or welded to the bottom plate 2.

Preferably, the bottom plate 2 and the side plates 31, 32 are made of same material, preferably aluminum, or different materials with similar temperature coefficients, to avoid damage due to different temperature deformations.

Each side plate 31, 32, comprises a corresponding flange 41, 42 on its outer side. The term “outer side” is intended to refer to the side of the side plates 31, 32 which does not define the internal volume 3. In other words, the flanges 41, 42 extend away from the internal volume 3.

The flanges 41, 42 are positioned approximately midway along the side plates 31, 32 and run along the whole length of the side plates 31, 32 in the exemplary implementation. However, other realizations of flanges 41, 42 are possible.

Each flange 41, 42 has holes for placing screws or other fastening means to fasten a flange 41, 42 of an individual supporting structure 1 to an adjacent flange 41, 42 of an adjacent supporting structure 1 as will be described with reference to FIG. 2 below. The flanges 41, 42 could also be fastened to a chassis or to any other receiving frame.

FIG. 2 illustrates a schematic view of a battery system 10 comprising two supporting structures 1A and 1B which are shown in the process of being interconnected.

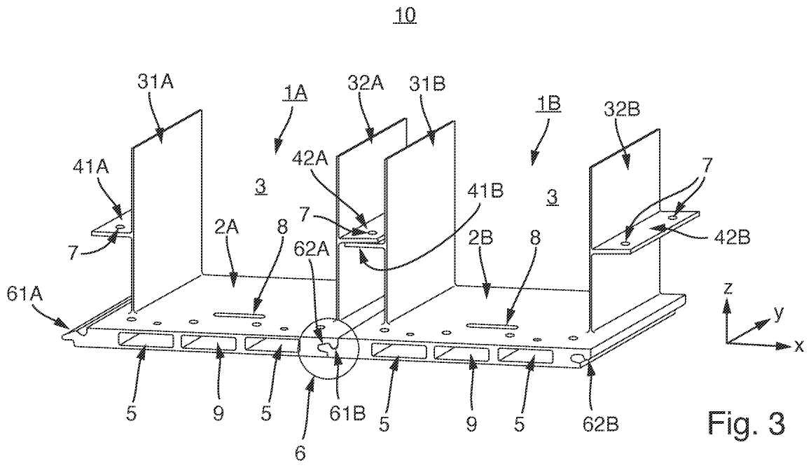

Attachment of the respective supporting structures 1A and 1B to each other takes place at two separate connection sites which are placed in two different planes relative to the bottom plate 2A. The first connection site is realized through connection of the bottom plates 2A and 2B to each other and is situated in the plane defined by the bottom plates 2A, 2B as will be seen in FIG. 3. The second connection site is realized by connecting the flanges 42A, 41B of the corresponding side plates 32A, 31B to each other and is realized in a plane parallel but distanced to the plane defined by the bottom plates 2A, 2B.

Bottom plates 2A and 2B are connected along the edges 62A and 61B by a clip connection. The edges 62A and 61B have a complementary geometry, such that after tilting and pressing both edges 62A and 62B towards each other, a tight connection between the two bottom plates 2A and 2B results in the plane defined by the bottom plates 2A, 2B.

The edges 61A, 61B, 62A, 62B of the bottom plate 2A, 2B run along the extrusion direction if the respective bottom plate 2A, 2B is made in an extrusion process.

After tilting and connecting adjacent bottom plates 2A and 2B to each other, the adjacent flanges 42A, 41B automatically come into close contact and are aligned with each other as shown in FIG. 3.

For this to happen, the flanges 41A, 41B on the left side plates 31A, 31B and the flanges 42A, 42B on the right side plates 32A, 32B are positioned at slightly different heights with respect to the bottom plates 2A, 2B, approximately midway along the side plates. The difference in height preferably roughly corresponds to the thickness of material of the flanges 41A, 41B, 42A, 42B such that any respective two adjacent flanges 42A, 41B do not collide but smoothly overlap.

In this process the holes 7 of the respective adjacent flanges 42A, 41B also slide into registration with each other such that the holes 7 on flanges 42A and 41B are finally positioned so, that after connecting the bottom plates 2A and 2B, the holes overlay. Screws may be placed into the holes 7 to fasten the flanges 42A and 41B to each other.

By such double connection of the supporting structures 1A, 1B, in particular in two planes distanced from each other, an especially stable and self-supporting battery system 10 may be provided. By using the flanges 41A and 42B at the outer side of the battery system 10, the battery system 10 may additionally be fastened to a chassis or to any other receiving frame without using the carrier plate or additional housing.

Further, the resulting space between the outer sides of the side plates 32A and 31B, may be used, for example for installing additional temperature control measures, for insertion of electrical cables etc.

In FIG. 3 the situation is shown in which two support structures 1A, 1B—e.g. the support structures known from FIG. 2, are finally connected. However, more than two supporting structures 1A, 1B can be combined to form a modular battery system 10 of dimensions needed for the respective purpose.

FIG. 4 illustrates a battery system 10 composed of two supporting structures 2A, 2B and with battery cells inserted in the inner volume 3A between the bottom plate 2A and the side plates 31A and 32A.

The battery cells 11 may be in direct contact with the bottom plate 2A and thus thermally coupled to the fluid channels 5 which are incorporated in the bottom plate 2A. The supporting structure 1 and battery cells 11, together with a front plate 12, a back plate (not shown in the Figure but similar to the front plate 12) and the module cover 13 hence form a battery module 100. A suitable number of such battery modules 100 may be connected together, to form a battery system 10 of desired size.

It will be obvious for a person skilled in the art that these embodiments and items only depict examples of a plurality of possibilities. Hence, the embodiments shown here should not be understood to form a limitation of these features and configurations. Any possible combination and configuration of the described features can be chosen according to the scope of the invention.

### LIST OF REFERENCE NUMERALS

1, 1A, 1B supporting structure
2, 2A, 2B bottom plate
3 internal volume
31, 32, 31A, 32A, 31B, 32B side plate
41, 42, 41A, 42A, 41B, 42B flange
5 fluid channels
6 clip connection
61, 61A, 61B male part of a clip connection
62, 62A, 62B female part of a clip connection
7 holes for screws
8 opening for venting system
9 venting channel
10 battery system
11 battery cell
12 front plate
13 module cover
100 battery module

1: A supporting structure for receiving battery cells in a battery system of at least one of: a hybrid vehicle and an electric vehicle, the supporting structure comprising a bottom plate and two side plates arranged on the bottom plate, wherein inner sides of the two side plates and the bottom plate define an internal volume for receiving the battery cells, and wherein each side plate comprises a flange at its outer side and wherein each flange comprises fixation means for fastening the supporting structure to an adjacent supporting structure.

2: The supporting structure according to claim 1, wherein the supporting structure is self-supporting.

3: The supporting structure according to claim 2, wherein at least one of: the bottom plate and the side plates are provided by an extruded material, by an extruded profile, and wherein the bottom plate and the side plates are integrally formed.

4: The supporting structure according to claim 3, wherein each flange extends from its respective side plate at an angle, perpendicularly.

5: The supporting structure according to claim 4, wherein the flange of one side plate of the two side plates is arranged at a different distance from the bottom plate as the flange of the other side plate of the two side plates.

6: The supporting structure according to claim 5, wherein the flanges on both side plates are positioned at slightly different heights, such that two flanges of adjacent supporting structures come into close contact upon interconnection of the corresponding bottom plates.

7: The supporting structure according to claim 6, wherein each flange is positioned approximately midway along the side plate.

8: The supporting structure according to claim 7, wherein each flange extends in a direction parallel to a plane defined by the bottom plate from its respective side plate further than the bottom plate, for forming an overlap between two adjacent flanges of two adjacent supporting structures.

9: The supporting structure according to claim 8, wherein the bottom plate comprises a fluid channel for receiving a temperature control fluid for controlling the temperature of the internal volume.

10: The supporting structure according to claim 9, wherein the bottom plate comprises a venting channel for receiving gases released from battery cells in case of thermal runaway.

11: The supporting structure according to claim 10, wherein the battery cells are positioned directly in the internal volume.

12: The supporting structure according to claim 11, wherein the side plates are at least one of: welded to the bottom plate, glued to the bottom plate, and fastened to the bottom plate by a form-locking connection, and fastened to the bottom plate by a screw connection.

13: The supporting structure according to claim 12, wherein the bottom plate comprises at least one edge having connection means.

14: A battery system comprising at least two supporting structures for receiving battery cells wherein the supporting structures are interconnected at the respective adjacent bottom plates as well as at respective adjacent flanges.

15: The battery system according to claim 14, wherein each bottom plate comprises connection means for enabling a clip connection of two adjacent bottom plates.

16: The battery system according to claim 14, wherein each supporting structure of the at least two supporting structures comprises a bottom plate of the respective bottom plates and two side plates arranged on the bottom plate, wherein inner sides of the two side plates and the bottom plate define an internal volume for receiving the battery cells, and wherein each side plate comprises a flange of the respective adjacent flanges at its outer side and wherein each flange comprises fixation means-for fastening the supporting structure to an adjacent supporting structure.

17: The supporting structure according to claim 5, wherein the distance of the flanges from the bottom plate differs by a thickness of the material of the flanges.

18: The supporting structure according to claim 9, wherein the temperature control fluid is configured to control the temperature of battery cells received within the internal volume.

19: The supporting structure according to claim 11, wherein the battery cells are positioned directly on the bottom plate and between the side plates of the supporting structure for forming a battery module.

20: The supporting structure according to claim 12, wherein the bottom plate comprises at least one edge having a connection geometry enabling at least one of: a form-locking and a clip connection with an adjacent supporting structure.
